(19) United States
(12) Patent Application Publication
(10) Pub. No.: US 2013/0154521 A1
(43) Pub. Date: Jun. 20, 2013

(54) Battery with Variable Output Voltage

(71) Applicants: Stefan Butzmann, Beilstein (DE); Holger Fink, Stuttgart (DE)

(72) Inventors: Stefan Butzmann, Beilstein (DE); Holger Fink, Stuttgart (DE)

(21) Appl. No.: 13/641,121

(22) PCT Filed: Feb. 16, 2011
(86) PCT No.: PCT/EP11/52283

§ 371 Date: Feb. 22, 2013

(30) Foreign Application Priority Data
Apr. 16, 2010 (DE) 102010027864.5

(51) Int. Cl. H02P 27/06; H02J 7/00

(52) U.S. Cl. CPC H02P 27/06; H02J 7/0063
USPC 318/139; 320/118

(57) ABSTRACT

A battery includes at least one battery module line and a control unit. The at least one battery module line has a plurality of battery modules mounted in series. Each battery module includes at least one battery cell and a coupling unit. The at least one battery cell is mounted between a first input and a second input of the coupling unit. The coupling unit is designed to switch the at least one battery cell between a first terminal of the battery module and a second terminal of the battery module, on a first control signal, and to connect the first terminal to the second terminal on a second control signal. The control unit is designed to transmit the first control signal to a first variable number of battery modules of the at least one battery module line.

The present invention relates to a battery with a variable output voltage.

### PRIOR ART

In future, the more widespread use of battery systems may be anticipated, both in stationary applications and in vehicles, such as hybrid and electric vehicles. In order to meet the relevant requirements for voltage and available capacity in any given application, a large number of battery cells are connected in series. As the current delivered by a battery of this type is required to pass through all the battery cells, and a battery cell can only conduct a limited current, battery cells are frequently provided with an additional parallel connection, in order to increase the maximum current. This may be achieved, either by the provision of a number of cell windings within a battery cell housing, or by the external interconnection of battery cells.

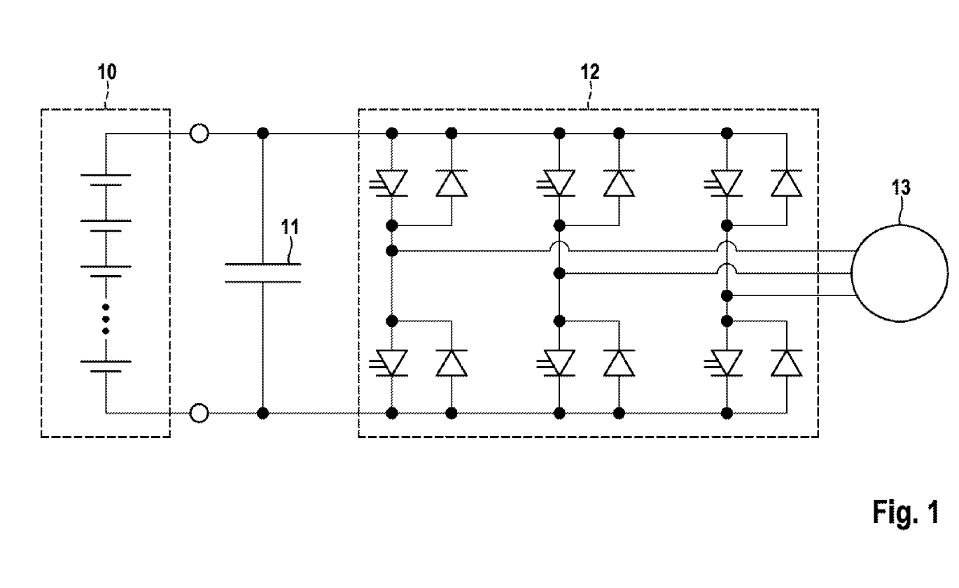

A basic circuit diagram of a conventional electric drive system of the type used e.g. in electric and hybrid vehicles or in stationary applications, such as the rotor blade adjustment system of a wind turbine installation, is shown in FIG. 1. A battery 10 is connected to an intermediate d.c. circuit, which is buffered by a capacitor 11. A pulse-controlled inverter 12 is connected to the intermediate d.c. circuit which, via two switchable semiconductor valves and two diodes in each case, delivers phase-displaced sinusoidal voltages to three outputs for the operation of an electric drive motor 13. The capacitor 11 must have sufficient capacity to stabilize the voltage in the intermediate d.c. circuit during the time interval associated with the switching of one of the switchable semiconductor valve elements. In a practical application, such as an electric vehicle, the requisite capacitance will be high, of the order of mFs. In the light of the customarily high voltage in the intermediate d.c. circuit, a capacitance of this magnitude can only be achieved at high cost and with substantial space requirements.

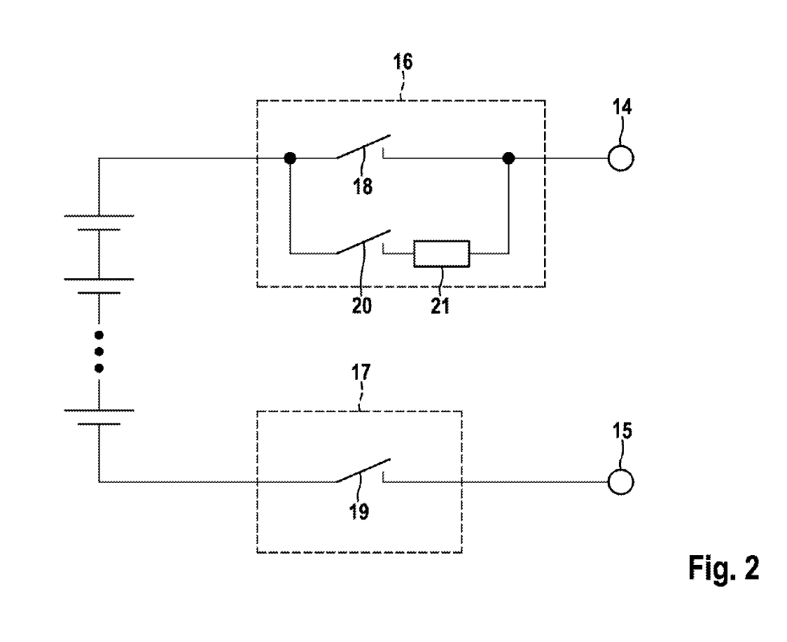

FIG. 2 shows a detailed block diagram of the battery 10 represented in FIG. 1. A plurality of battery cells are connected in series, with an additional optional parallel connection, in order to deliver an output voltage and a battery capacity of the required magnitude for the application concerned. A charging and disconnecting device 16 is connected between the positive pole of the battery cells and a positive battery terminal 14. As an additional option, a disconnecting device 17 may be connected between the negative pole of the battery cells and a negative battery terminal 15. The disconnecting and charging device 16 and the disconnecting device 17 are each provided with a contactor 18, 19 for the separation of the battery cells from the battery terminals, thereby isolating the battery terminals from supply. The high d.c. voltage of the series-connected battery cells would otherwise pose a substantial hazard to maintenance personnel or similar. In the charging and disconnecting device 16, a charging contactor 20 is also provided, with a charging resistance 21 connected in series to the charging contactor 20. The charging resistance 21 restricts the charging current in the capacitor 11, when the battery is connected to the intermediate d.c. circuit. To this end, the contactor 18 is initially left in the open position, and only the charging contactor 20 is closed. Once the voltage on the positive battery terminal 14 achieves the battery cell voltage, the contactor 19 may be closed and the charging contactor 20 may be opened, where applicable. The contactors 18, 19 and the charging contactor 20 considerably increase the costs associated with a battery 10, in the light of the stringent requirements in force for the reliability and current-carrying capacity of these elements.

### DISCLOSURE OF THE INVENTION

According to the invention, a battery is therefore disclosed which comprises at least one battery module line and a control unit, in which the minimum of one battery module line comprises a plurality of series-connected battery modules. Each battery module comprises at least one battery cell and a coupling unit. The minimum of one battery cell is connected between a first input and a second input of the coupling unit. The coupling unit is designed to switch the minimum of one battery cell between a first terminal of the battery module and a second terminal of the battery module in response to a first control signal, and to connect the first terminal to the second terminal in response to a second control signal. The control unit is designed to transmit the first control signal to a first variable number of battery modules in the minimum of one battery module line and the second control signal to the remaining battery modules in the minimum of one battery module line, thereby allowing the variable regulation of the output voltage of the minimum of one battery module line of the battery.

The coupling unit allows for one or more battery cells connected between the first input and the second input either to be coupled to first and second outputs of the coupling unit, such that the voltage of the battery cells is available for external use, or for the battery cells to be bridged by the connection of the first output to the second output, such that the externally available voltage is 0V.

In this way, by the appropriate control of the coupling units of the series-connected battery modules in a battery module line, it is possible to set a variable output voltage for the battery module line by the simple activation (battery cell voltage available at the coupling unit output) or deactivation (zero output voltage of the coupling unit) of a corresponding number of battery modules.

The invention offers advantages, in that the function of the pulse-controlled inverter can be directly integrated into the battery, and a buffer capacitor for the buffering of an intermediate d.c. circuit is superfluous, and can be omitted accordingly.

In the extreme case, each battery module comprises only one battery cell, or battery cells connected exclusively in parallel. This arrangement permits the finest adjustment of the output voltage of a battery module line. If, as preferred, lithium ion battery cells are used, with a cell voltage ranging from 2.5 to 4.2V, the output voltage of the battery can be adjusted to a corresponding margin of accuracy. The more accurate the adjustment of the battery output voltage, the less significant the issue of electromagnetic compatibility will be, as the radiation generated by the battery current will fall in proportion to the high-frequency components thereof. However, this is achieved at the cost of more complex circuitry which, given the use of multiple switches, is also associated with increased energy losses in the switches of the coupling units.

The control unit is preferably designed for the adjustment of a sinusoidal output voltage of the minimum of one battery module line. Sinusoisal output voltages permit the direct connection of components which have been designed to operate on an a.c. system.

Preferably, the control unit is also designed for the adjustment of the sinusoidal output voltage to an adjustable and preselectable frequency. In this case, the battery may be comprised of multiple battery module lines, preferably three battery module lines. For each battery module line, the control unit is designed for the setting of a sinusoidal output voltage which is phase-displaced in relation to the sinusoidal output voltages of the other battery module lines. Specifically, the form of embodiment with three battery module lines permits the direct connection of an electric motor without further intermediate components. As a result, in comparison to the system represented in FIG. 1, a drive system of an electric or hybrid vehicle can be reduced to the battery according to the invention and an electric drive motor. However, it is also conceivable that an electric motor might be provided with more inputs for phase signals, in which case corresponding batteries with more battery module lines would be appropriate.

The coupling unit may be provided with a first output and is designed, in response to the first control signal, to connect either the first input or the second input to the output. Accordingly, the output is connected to one terminal of the battery module, and either the first or the second input is connected to the other terminal of the battery module. A coupling unit of this type can be constructed by the use of just two switches, preferably semiconductor switches such as MOSFETs or IGBTs.

Alternatively, the coupling unit may be provided with a first output and a second output and designed such that, in response to the first control signal, the first input is connected to the first output and the second input is connected to the second output. The coupling unit is also designed such that, in response to the second control signal, the first input is disconnected from the first output, the second input is disconnected from the second output, and the first output is connected to the second output. Although this form of embodiment requires somewhat more complex circuitry (generally three switches), the coupling of the battery cells of the battery module at both of its poles is such that, in case of impending exhaustion or damage to a battery module, the constituent battery cells thereof can be isolated from supply and thus safely replaced while the unit as a whole remains in service.

A second aspect of the invention relates to a motor vehicle with an electric drive motor for the propulsion of the motor vehicle, and a battery according to the first aspect of the invention which is connected to to the electric drive motor.

### DIAGRAMS

Examples of embodiment of the invention are presented in greater detail with reference to the diagrams and the following description, in which the same reference signs refer to identical or functionally similar components. In the diagrams:

FIG. 1 shows an electric drive system according to the prior art,

FIG. 2 shows a block diagram of a battery according to the prior art,

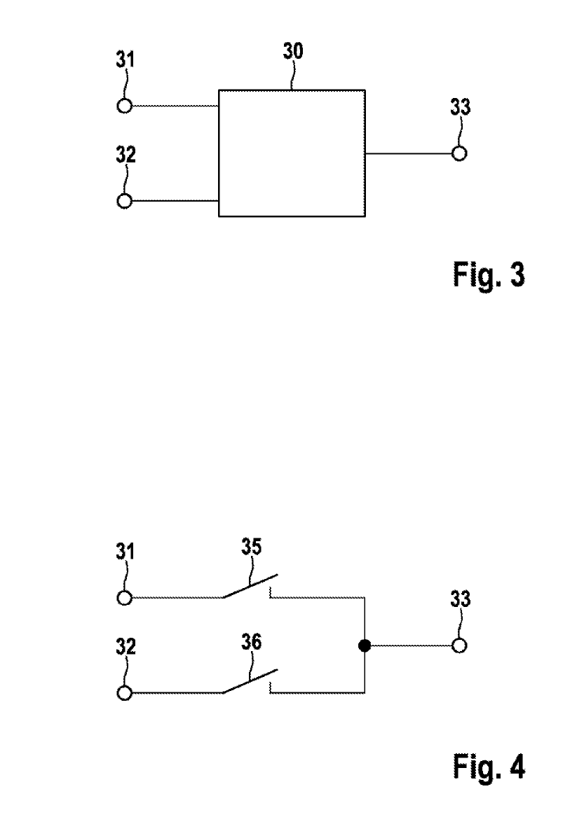

FIG. 3 shows a first form of embodiment of a coupling unit for use in the battery according to the invention,

FIG. 4 shows a possible circuit re-arrangement of the first form of embodiment of the coupling unit,

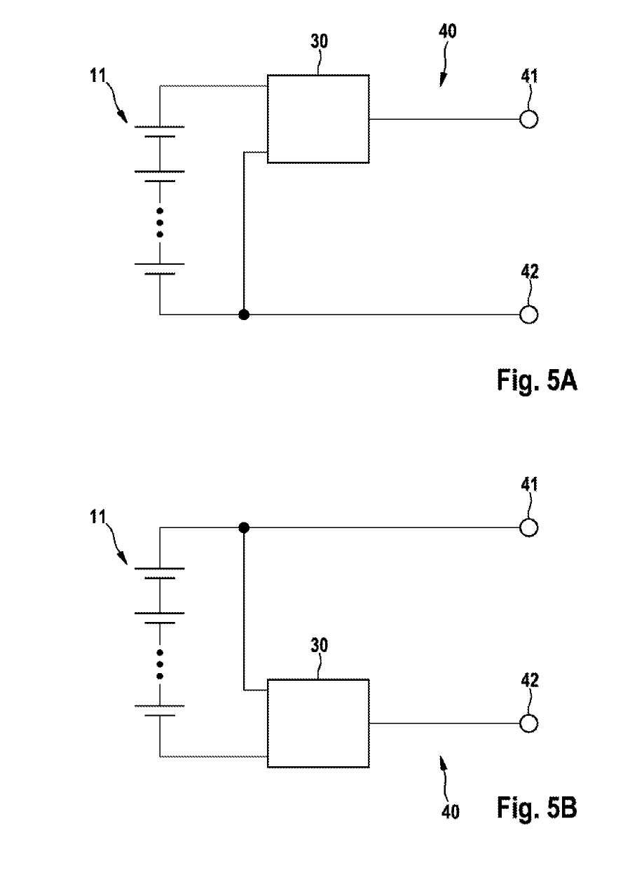

FIGS. 5A and 5B show two forms of embodiment of a battery module with the first form of embodiment of the coupling unit,

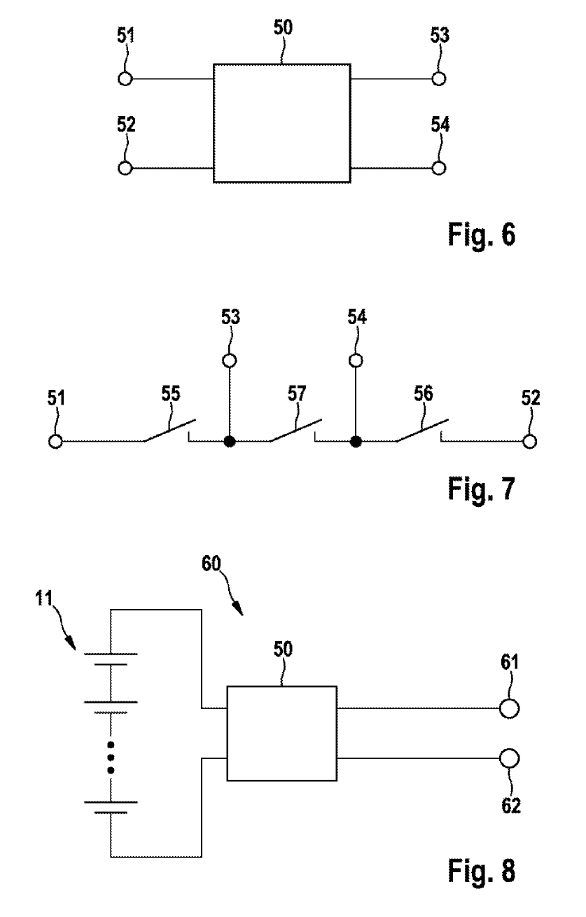

FIG. 6 shows a second form of embodiment of a coupling unit for use in the battery according to the invention,

FIG. 7 shows a possible circuit-rearrangement of the second form of embodiment of the coupling unit,

FIG. 8 shows a form of embodiment of a battery module with the second form of embodiment of the coupling unit,

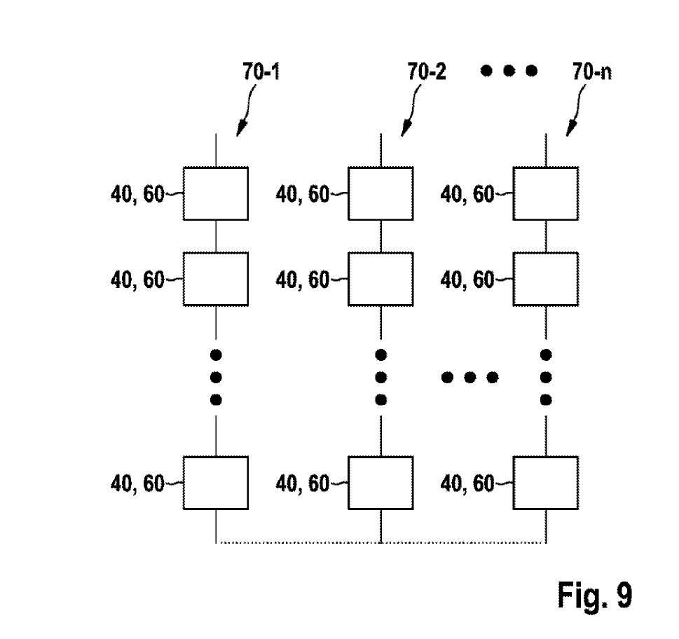

FIG. 9 shows a first form of embodiment of the battery according to the invention,

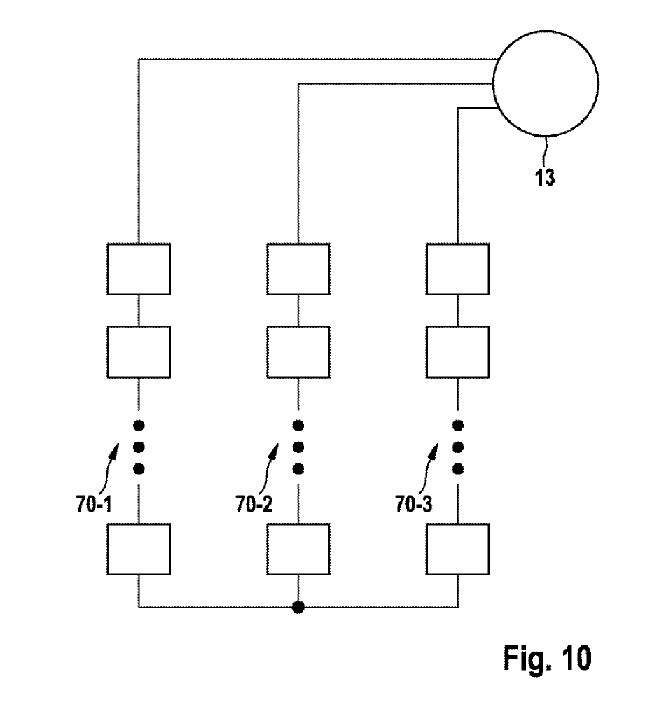

FIG. 10 shows a drive system with a further form of embodiment of the battery according to the invention, and

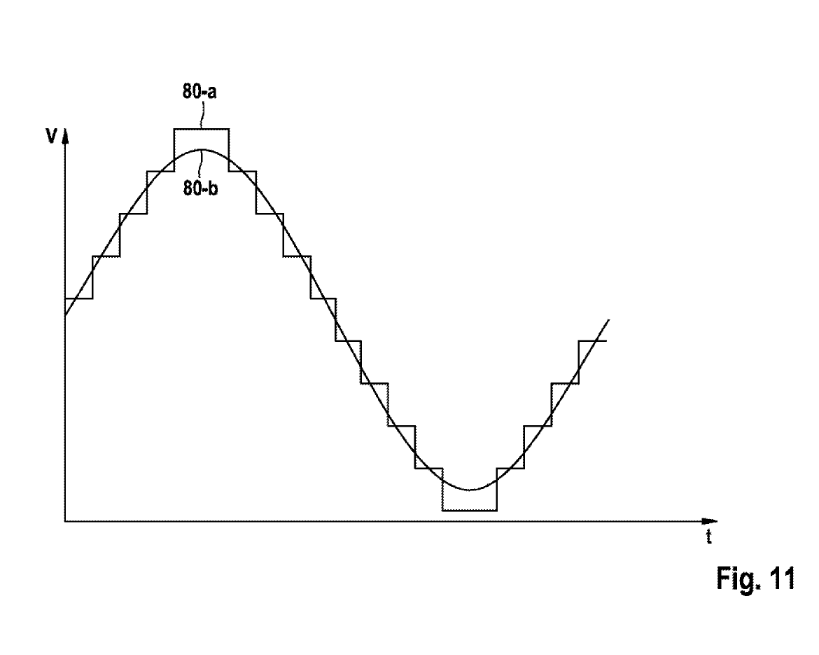

FIG. 11 shows a time characteristic of an output voltage of the battery according to the invention.

### FORMS OF EMBODIMENT OF THE INVENTION

FIG. 3 shows a first form of embodiment of a coupling unit 30 for use in the battery according to the invention. The coupling unit 30 is provided with two inputs 31 and 32 and an output 33, and is designed for the connection of one of the inputs 31 or 32 to the output 33, and for the disconnection of the other.

FIG. 4 shows a possible circuit re-arrangement of the first form of embodiment of the coupling unit 30, in which a first switch and a second switch 35, 36 are provided. Each of the switches is connected between one of the inputs 31, 32 and the output 33. This form of embodiment has an advantage, in that both inputs 31, 32 can also be disconnected from the output 33, thereby resulting in the high resistance of the output 33, which may be useful e.g. in case of repair or maintenance. Moreover, the switches 35, 36 can also be simply configured as semiconductor switches such as e.g. MOSFETs or IGBTs. Semiconductor switches offer the combined advantage of low cost and high operating speed, thereby permitting the coupling unit 30 to respond to a control signal or an adjustment to the control signal within a short space of time, with the consequent achievement of rapid switching rates. However, in comparison with a conventional pulse-controlled inverter, which generates the desired voltage waveform by the corresponding selection of a pulse duty factor between the maximum and minimum d.c. voltage (pulse-width modulation), the invention has an advantage, in that the switching frequencies of the constituent switches of the coupling unit are significantly lower, thereby improving electromagnetic compatibility (EMC) and imposing less stringent requirements upon the switches.

FIGS. 5A and 5B show two forms of embodiment of a battery module 40 with the first form of embodiment of the coupling unit 30. A plurality of battery cells 11 are connected in series between the inputs of the coupling unit 30. However, the invention is not restricted to such a series connection of battery cells 11, but may also include the provision of a single battery cell 11 only, or a parallel connection, or a combined series-parallel connection of battery cells 11. In the example shown in FIG. 5A, the output of the coupling unit 30 is connected to a first terminal 41, and the negative pole of the battery cells 11 is connected to a second terminal 42. However, an essentially mirror image of this arrangement is possible, as shown in FIG. 5B, in which the positive pole of the battery cells 11 is connected to the first terminal 41, and the output of the coupling unit 30 is connected to the second terminal 42.

FIG. 6 shows a second form of embodiment of a coupling unit 50 for use in the battery according to the invention. The coupling unit 50 is provided with two inputs 51 and 52 and two outputs 53 and 54. It is designed, either for the connection of the first input 51 to the first output 53 and of the second input 52 to the second output 54 (and for the disconnection of the first output 53 from the second output 54), or for the connection of the first output 53 to the second output 54 (and for the disconnection of the inputs 51 and 52). In specific forms of embodiment of the coupling unit, the latter may also be designed for the isolation of the both inputs 51, 52 from the outputs 53, 54, and also for the disconnection of the first output 53 from the second output 54. However, there is no provision for the connection of the first input 51 to the second input 52.

FIG. 7 shows a possible circuit re-arrangement of the second form of embodiment of the coupling unit 50, in which a first switch, a second switch and a third switch 55, 56 and 57 are provided. The first switch 55 is connected between the first input 51 and the first output 53, the second switch 56 is connected between the second input 52 and the second output 54, and the third switch 57 is connected between the first output 53 and the second output 54. This form of embodiment also provides an advantage, in that the switches 55, 56 and 57 may be simply provided in the form of semiconductor switches such as e.g. MOSFETs or IGBTs. Semiconductor switches offer the benefit of low cost and high operating speed, thereby permitting the coupling unit 50 to respond to a control signal or an adjustment to the control signal within a short space of time, with the achievement of rapid switching rates.

FIG. 8 shows a form of embodiment of a battery module 60, with the second form of embodiment of the coupling unit 50. A plurality of battery cells 11 are connected in series between the inputs of a coupling unit 50. This form of embodiment of the battery module 60 is likewise not restricted to such a series connection of battery cells 11, but may also include the provision of a single battery cell 11 only, or a parallel connection, or a combined series-parallel connection of battery cells 11. The first output of the coupling unit 50 is connected to a first terminal 61, and the second output of the coupling unit 40 is connected to a second terminal 62. In comparison with the battery module 40 represented in FIGS. 5A and 5B, the battery module 60 has an advantage, in that the battery cells 11 may be isolated from the remainder of the battery by the coupling unit 50 on either side, thereby permitting the hazard-free replacement thereof under in-service conditions, as neither pole of the battery cells 11 will carry the hazardous high aggregate potential of the remaining battery modules in the battery.

FIG. 9 shows a first form of embodiment of the battery according to the invention, which is provided with n battery module lines 70-1 to 70-n. Each battery module line 70-1 to 70-n comprises a plurality of battery modules 40 or 60, whereby each battery module line 70-1 to 70-n preferably comprises the same number of battery modules 40 or 60, and each battery module 40 or 60 preferably comprises the same number of battery cells 11, connected in an identical manner. One pole on one of the battery module lines 70-1 to 70-n may be connected to a corresponding pole on the other battery module line 70-1 to 70-n, as represented in FIG. 9 by a dotted line. In general, a battery module line 70-1 to 70-n may comprise any number of battery modules 40 or 60 greater than 1, and a battery may comprise any number of battery module lines 70-1 to 70-n. The poles of the battery module lines 70-1 to 70-n may also be provided with charging/disconnecting and disconnecting devices, as represented in FIG. 2, where safety requirements dictate. However, disconnecting devices of this type are not necessary according to the invention, as the isolation of the battery cells 11 from the battery connections can be achieved by means of the coupling units 30 or 50 incorporated in the battery modules 40 or 60.

FIG. 10 shows a drive system with a further form of embodiment of the battery according to the invention. In the example shown, the battery is provided with three battery module lines 70-1, 70-2 and 70-3, each of which is directly connected to one input of a drive motor 13. As the majority of available electric motors are designed for operation with three phase signals, the battery according to the invention is preferably provided with precisely three battery module lines. The battery of the invention has a further advantage, in that the function of a pulse-controlled inverter is incorporated into the battery by design. As a control unit of the battery can activate (or deactivate) a variable number of battery modules 40 or 60 in a battery module line, the output of the battery module line makes available a voltage which is proportional to the number of activated battery modules 40 or 60, and which may range from 0V to the full output voltage of the battery module line.

FIG. 11 shows a time characteristic of an output voltage of the battery according to the invention. The output voltage of the battery (or of a battery module line) V is plotted against time t. The reference sign 80-b indicates a notional (ideal) sine curve for an exemplary application in which, however, the voltage values are only equal to or greater than zero. A discrete-value voltage curve 80-a generated by the battery according to the invention approximates to the ideal sine. The magnitude of the deviations of the discrete-value voltage curve 80-a from the ideal curve 80-b is dependent upon the number of battery cells 11 which are connected in series in a battery module 40 or 60. The smaller the number of battery cells 11 which are connected in series in a battery module 40 or 60, the more accurately the discrete-value voltage curve 80-a will follow the ideal curve 80-b. However, in customary applications, the relatively small deviations will not impair the function of the system as a whole. In comparison with a conventional pulse-controlled inverter, which can only provide a binary output voltage which must then be filtered by down-circuit switching components, these deviations are, in any case, substantially reduced.

In addition to the advantages already mentioned, the invention also provides the advantage of a reduction in the number of high-voltage components and plug-in connectors, and offers an option for the combination of a cooling system of the battery with that of the pulse-controlled inverter, wherein a coolant which is used for the cooling of the battery cells can be used thereafter for the cooling of the components of the pulse-controlled inverter (i.e. of the coupling unit 40 or 60), as these will generally achieve higher service temperatures, and cannot be sufficiently cooled by the coolant which has already been heated by the battery cells. It also becomes possible for the control units of the battery and of the pulse-controlled inverter to be combined, thereby delivering a further saving in expenditure. The coupling units provide an integral safety function for the pulse-controlled inverter and the battery, and enhance the reliability and availability of the overall system, together with the service life of the battery.

A further advantage of the battery with an integral pulse-controlled inverter is that it permits a highly straightforward form of modular construction, using individual battery modules with integrated coupling unit. This permits the use of standard components (in a building block system).

1. A battery comprising:
at least one battery module line including a plurality of series-connected battery modules; and
a control unit,
wherein each battery module of the plurality of series-connected battery modules includes (i) at least one battery cell and (ii) a coupling unit,
wherein the at least one battery cell is connected between a first input and a second input of the coupling unit,
wherein the coupling unit is configured (i) to switch the at least one battery cell between a first terminal of the battery module and a second terminal of the battery module in response to a first control signal, and (ii) to connect the first terminal to the second terminal in response to a second control signal, and
wherein the control unit is configured (i) to transmit the first control signal to a first variable number of the battery modules of the plurality of series-connected battery modules and (ii) to transmit the second control signal to a remaining number of the battery modules of the plurality of series-connected battery modules, thereby enabling variable regulation of an output voltage of the at least one battery module line.

2. The battery as claimed in claim 1, wherein the control unit is configured to adjust a sinusoidal output voltage of the at least one battery module line.

3. The battery as claimed in claim 2, wherein the control unit is configured to adjust the sinusoidal output voltage to an adjustable and preselectable frequency.

4. The battery as claimed in claim 2, wherein:
the battery includes three of the at least one battery module lines, and
for each of the battery module lines, the control unit is configured to set a sinusoidal output voltage which is phase-displaced in relation to the sinusoidal output voltages of the other battery module lines.

5. The battery as claimed in claim 1, wherein the coupling unit (i) includes a first output and (ii) is configured, in response to the first control signal, to connect either the first input or the second input to the first output.

6. The battery as claimed in claim 1, wherein the coupling unit includes a first output and a second output and is configured such that, (i) in response to the first control signal, the first input is connected to the first output and the second input is connected to the second output and, (ii) in response to the second control signal, the first input is disconnected from the first output, the second input is disconnected from the second output, and the first output is connected to the second output.

7. A motor vehicle comprising:
an electric drive motor configured to propel the motor vehicle; and
a battery which is connected to the electric drive motor,
wherein the battery includes (i) at least one battery module line having a plurality of series-connected battery modules, and (ii) a control unit,
wherein each battery module of the plurality of series-connected battery modules includes (i) at least one battery cell and (ii) a coupling unit,
wherein the at least one battery cell is connected between a first input and a second input of the coupling unit,
wherein the coupling unit is configured (i) to switch the at least one battery cell between a first terminal of the battery module and a second terminal of the battery module in response to a first control signal, and (ii) to connect the first terminal to the second terminal in response to a second control signal, and
wherein the control unit is configured (i) to transmit the first control signal to a first variable number of battery modules of the plurality of series-connected battery modules and (ii) to transmit the second control signal to a remaining number of the battery modules of the plurality of series-connected battery modules, thereby enabling variable regulation of an output voltage of the at least one battery module line.
